(19) United States
(12) Patent Application Publication
(10) Pub. No.: US 2025/0303853 A1
(43) Pub. Date: Oct. 2, 2025

(54) VEHICULAR LID OPEN/CLOSE DEVICE

(71) Applicant: TOYODA GOSEI CO., LTD., Kiyosu-shi (JP)

(72) Inventors: Kenichiro KANEKO, Kiyosu-shi (JP); Naoki TOKUDOME, Kiyosu-shi (JP); Kengo SAKAI, Kiyosu-shi (JP); Taiji HIMENO, Kiyosu-shi (JP); Kohei SHIROTA, Kiyosu-shi (JP); Daisuke FUJII, Kiyosu-shi (JP); Ryuhei HANADA, Kiyosu-shi (JP); Kazuki FUJISAWA, Kiyosu-shi (JP)

(21) Appl. No.: 19/077,673

(22) Filed: Mar. 12, 2025

(30) Foreign Application Priority Data
Mar. 27, 2024 (JP) 2024-052578

(51) Int. Cl. B60K 15/05

(52) U.S. Cl. CPC B60K 15/05; B60K 2015/053

(57) ABSTRACT

A vehicular lid open/close device includes a base body, a lid movable between closed and opened positions where a base-body opening is closed/opened, and an open/close mechanism for performing lid-open/close movement. The open/close mechanism has an arm supporting the lid openably/closably relative to the base body. The arm has first and second arm portions on upper and lower sides. The first and second arm portions have parts extending horizontally at a lid-closed position. The base body has a base-body-side first and second bearing portions pivotably supporting the first and second arm portions. The open/close mechanism has a fixation preventing structure which prevents fixation of pivoting of the arm due to put-water solidification and is formed between the base body and the arm over a range from a position at a predetermined radial-direction distance from a base-body-side axis to a lid-side end of the arm, at the lid-closed position.

### FIELD

The present disclosure relates to a vehicular lid open/close device.

### BACKGROUND ART

Conventionally, there has been known a vehicular lid open/close device for opening/closing a replenishment port such as a charge port for energy replenishment for a vehicle by using a lid (see, for example, Japanese Patent No. 5617506). The vehicular lid open/close device described in Japanese Patent No. 5617506 includes a box-shaped base body having a storage space storing a replenishment port, a lid for covering a front-side opening of the base body, and an open/close mechanism which performs open/close movement of the lid relative to the base body between a closed position and an opened position. The open/close mechanism has a pair of arms (5a, 5b) on the left and right sides.

Each arm extends so as to connect the base body and the lid. Each arm has one end pivotably supported by the base body and another end pivotably supported by the lid. The pair of arms are located adjacently to each other and operate in coordination with each other to open/close the lid relative to the base body.

### SUMMARY OF INVENTION

### Technical Problem

However, when the arms are in a state in which the lid is between the closed position and the opened position (in particular, the lid is at the closed position), if there is such a structure that water is likely to be put and accumulated between the arms or between each arm and the base body especially at a horizontal part or the like, pivoting operation of the arms is hampered by the put water being frozen and solidified, and as a result, opening/closing of the lid is disabled.

The present disclosure has been made in view of the above circumstances, and an object of the present disclosure is to provide a vehicular lid open/close device that prevents fixation of pivoting of arms due to solidification of put water.

### Solution to Problem

An aspect of the present disclosure is a vehicular lid open/close device including: a box-shaped base body attached to a vehicle body and having a storage space storing a replenishment port for energy replenishment for a vehicle, and a front-side opening through which the replenishment port in the storage space is exposed to a vehicle outer side; a lid movable between a closed position where the front-side opening is closed and the replenishment port is covered, and an opened position where the front-side opening is opened and the replenishment port is exposed to the vehicle outer side; and an open/close mechanism configured to perform open/close movement of the lid relative to the base body between the closed position and the opened position. The open/close mechanism has an arm extending so as to connect the base body and the lid and supporting the lid openably/closably relative to the base body, the arm being configured to be stored in the storage space at the closed position of the lid. The arm includes a first arm portion supported by the base body pivotably about a base-body-side first axis on the base body side, and supported by the lid pivotably about a lid-side first axis on the lid side, and a second arm portion located below the first arm portion, the second arm portion being supported by the base body pivotably about a base-body-side second axis extending in parallel to the base-body-side first axis on the base body side, and the second arm portion being supported by the lid pivotably about a lid-side second axis extending in parallel to the lid-side first axis on the lid side. The first arm portion and the second arm portion have parts extending in a horizontal direction at least at the closed position of the lid. The base body has a base-body-side first bearing portion provided so as to face the storage space and supporting the first arm portion pivotably about the base-body-side first axis, and a base-body-side second bearing portion provided so as to face the storage space and supporting the second arm portion pivotably about the base-body-side second axis. The open/close mechanism has a fixation preventing structure configured to prevent fixation of pivoting of the arm due to solidification of put water, the fixation preventing structure being formed between the base body and the first arm portion over a range from a first position at a first predetermined distance in a radial direction from the base-body-side first axis to an end on the lid side of the first arm portion, or being formed between the base body and the second arm portion over a range from a second position at a second predetermined distance in the radial direction from the base-body-side second axis to an end on the lid side of the second arm portion, at the closed position of the lid.

With this configuration, fixation of pivoting of the arm due to solidification of put water is prevented.

### BRIEF DESCRIPTION OF DRAWINGS

FIG. 1 shows a state in which a vehicular lid open/close device according to an embodiment of the present disclosure is attached to a vehicle body and a lid is at a closed position, as seen from the vehicle outer side;

FIG. 2 shows a state in which the lid of the vehicular lid open/close device of the embodiment is at an opened position, as seen from the vehicle outer side;

FIG. 3 is an exploded view of the vehicular lid open/close device of the embodiment;

FIG. 4 is a perspective view of a base body included in the vehicular lid open/close device of the embodiment, as seen in an approximately horizontal direction from the vehicle outer side;

FIG. 5 is a front view of the base body included in the vehicular lid open/close device of the embodiment, as seen in an obliquely downward direction from the vehicle outer side;

FIG. 6 shows the base body and an arm included in the vehicular lid open/close device of the embodiment, as seen from the vehicle outer side;

FIG. 7 shows a fixation preventing structure for a first arm portion of an open/close mechanism included in the vehicular lid open/close device of the embodiment;

FIG. 8 shows a fixation preventing structure for a second arm portion of the open/close mechanism included in the vehicular lid open/close device of the embodiment;

FIG. 9 shows a sloped shape of a bearing plate portion as the fixation preventing structure included in the vehicular lid open/close device of the embodiment; and

FIG. 10 shows (A) a sloped shape of the arm and (B) a water drain path of the arm as the fixation preventing structure included in the vehicular lid open/close device of the embodiment.

### DESCRIPTION OF EMBODIMENTS

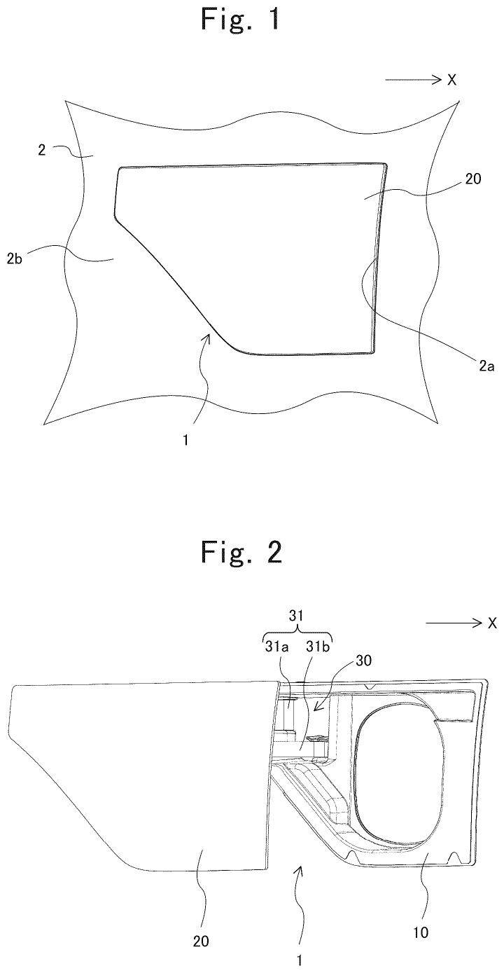

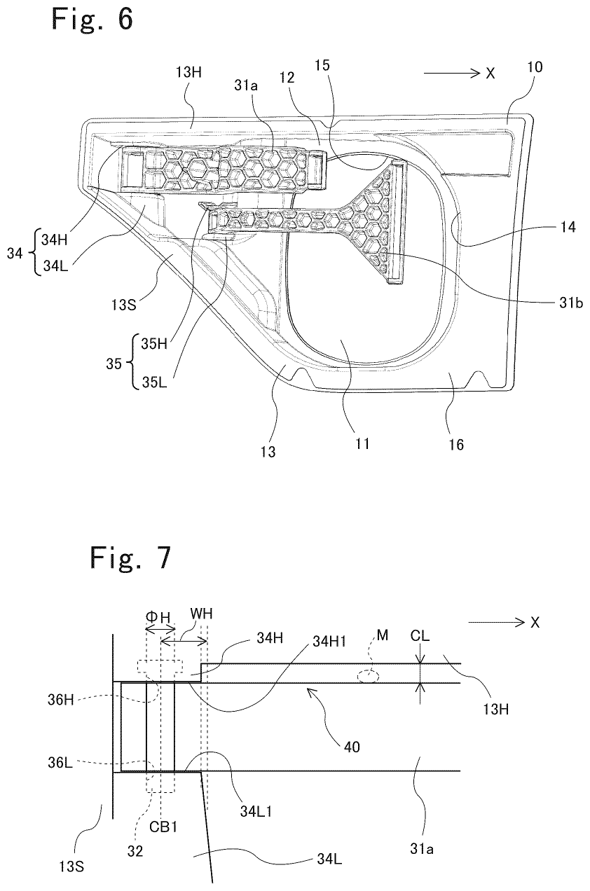

Hereinafter, with reference to FIG. 1 to FIG. 10, a specific embodiment of a vehicular lid open/close device according to the present disclosure will be described.

A vehicular lid open/close device 1 of the present embodiment is a device for opening/closing a replenishment port provided to a vehicle by using a lid. The vehicle to which the vehicular lid open/close device 1 is provided is a gasoline vehicle, a diesel vehicle, an electric vehicle, a hybrid vehicle, or a fuel cell vehicle, for example. The replenishment port which is a target to be opened/closed by the vehicular lid open/close device 1 is provided at a side surface, a forward surface, or the like of a vehicle body 2 (see FIG. 1), and is located at a vehicle body opening 2a (see FIG. 1) penetrating the vehicle body 2 in the in-out direction (i.e., front-back direction). The vehicle body opening 2a may be opened in a lateral direction of the vehicle as shown in FIG. 1 and FIG. 2, or may be opened in a direction such as a forward direction, a rearward direction, or an obliquely upward direction of the vehicle.

The replenishment port is a fuel port or a charge port provided for energy replenishment such as refueling or battery charging to the vehicle. The replenishment port is provided at one end of a tube or an electric wire. Another end of the tube or the electric wire is connected to a fuel tank, a battery, or the like provided on the vehicle body back side (i.e., vehicle body inner side). The replenishment port may be covered by a cap openable/closable by an operator. A refueling gun or a charging gun for energy replenishment is connected to the replenishment port in a cap opened state.

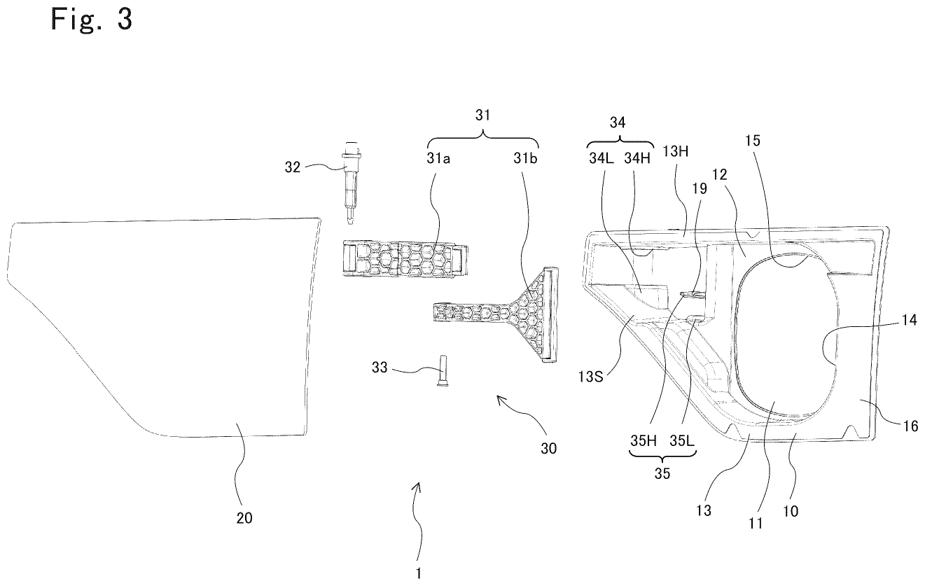

The vehicular lid open/close device 1 includes a base body 10, a lid 20, and an open/close mechanism 30, as shown in FIG. 2 and FIG. 3.

The base body 10 is a box-shaped box body storing the replenishment port. The base body 10 is attached to the vehicle body 2. Specifically, the base body 10 is attached so as to be fitted to the vehicle body opening 2a provided to the vehicle body 2. The base body 10 has a storage space 11, a bottom wall 12, a side wall 13, a front-side opening 14, a back-side opening 15, and a frame 16.

The storage space 11 is a space storing the replenishment port. The storage space 11 is surround by the bottom wall 12 and the side wall 13. The bottom wall 12 is a plate wall part having a polygonal shape (e.g., a quadrangular plate shape), a circular shape, or an elliptic shape. The bottom wall 12 is formed in, for example, a shape having a long upper side and a short lower side (i.e., a reverse trapezoidal shape), as shown in FIG. 1, etc. The side wall 13 is a wall part erected from the edge of the bottom wall 12 toward the vehicle outer side so as to surround the peripheral edge of the bottom wall 12. For example, in a case where the bottom wall 12 is formed in a quadrangular plate shape, the side wall 13 is formed such that four plate walls are connected in a peripheral direction along the edge of the bottom wall 12. The side wall 13 is formed by, for example, a wall extending in the horizontal direction, a wall extending in the vertical direction, a wall extending in a direction oblique to the horizontal direction, and the like.

The front-side opening 14 is an opening through which the replenishment port in the storage space 11 is exposed to the vehicle outer side. The front-side opening 14 is provided on a side opposite to the bottom wall 12 across the storage space 11 in the base body 10. The front-side opening 14 is closed when the lid 20 is at the closed position, and is opened when the lid 20 is not at the closed position. When the front-side opening 14 is opened, the replenishment port in the storage space 11 is exposed to the vehicle outer side through the front-side opening 14. The base body 10 is attached to the vehicle body 2 such that the front-side opening 14 faces in the horizontal direction or a direction tilted upward relative to the horizontal direction from the vehicle body inner side toward the vehicle body outer side, for example.

The back-side opening 15 is an opening through which the replenishment port is exposed from the vehicle inner side to the storage space 11. The back-side opening 15 is provided in the bottom wall 12 of the base body 10 so as to penetrate between the vehicle inner side and the vehicle outer side. The back-side opening 15 is formed in, for example, a circular shape, an elliptic shape, a rectangular shape, or the like in the bottom wall 12 of the base body 10, in accordance with the sectional shape of the replenishment port, or the like.

The frame 16 is formed in an annular shape along the peripheral edge of the front-side opening 14. The frame 16 is formed in a flange shape so as to extend from the peripheral edge of the front-side opening 14 toward the frame outer side. The base body 10 is positioned at the vehicle body 2 by the back surface of the frame 16 contacting with the front surface of the peripheral edge of the vehicle body opening 2a of the vehicle body 2, for example.

The lid 20 is a lid member for opening/closing the front-side opening 14 and therefore the replenishment port. The lid 20 is movable between the closed position where the front-side opening 14 is closed and the replenishment port is covered, and the opened position (specifically, fully opened position) where the front-side opening 14 is opened and the replenishment port is exposed to the vehicle outer side. The lid 20 performs open/close movement relative to the base body 10 by a later-described open/close mechanism 30 operating with an external force based on an operation by an operator or motive power produced by an electric motor, for example.

The lid 20 is formed in a plate shape so as to close the front-side opening 14 of the base body 10. The lid 20 is formed in a size and a shape (e.g., a substantially rectangular shape) corresponding to the front-side opening 14. The lid 20 closes the front-side opening 14 so as to be flush with the vehicle body surface 2b and the frame 16 around the peripheral edge of the front-side opening 14, at the closed position of the lid 20. The front surface of the lid 20 may be curved along the vehicle body surface 2b.

The lid 20 is formed by a lid lower portion and a lid upper portion, for example. The lid 20 is formed by the lid lower portion and the lid upper portion being attached and integrated with each other. When the lid 20 contacts with a full-open stopper so that movement of the lid 20 is restricted, the lid 20 may reach the fully opened position and be retained, or when an energizing force by an energizing member (not shown) becomes zero, the lid 20 may reach the fully opened position and be retained.

The open/close mechanism 30 is a mechanism for performing open/close movement of the lid 20 between the closed position and the opened position. Specifically, the open/close mechanism 30 slides the lid 20 in a substantially horizontal direction (hereinafter, referred to as a horizontal direction X) along the vehicle body surface 2b which is a front surface of the vehicle body 2, between the closed position and the opened position. The open/close mechanism 30 may provide motive power of at least one of an opening force or a closing force to the lid 20, using an electric motor. The open/close mechanism 30 has an arm 31.

The arm 31 is an arm-shaped member extending so as to connect the base body 10 and the lid 20 and supporting the lid 20 openably/closably relative to the base body 10. The arm 31 is stored in the storage space 11 of the base body 10 at the closed position of the lid 20. The arm 31 is configured to slide the lid 20 along the vehicle body surface 2b relative to the base body 10 when the lid 20 is opened/closed. The arm 31 is composed of a pair of arm portions and has a first arm portion 31a and a second arm portion 31b.

The first arm portion 31a and the second arm portion 31b perform, by pivoting, open/close movement of the lid 20 relative to the base body 10 between the closed position and the opened position, and specifically, cause the lid 20 to slide along the vehicle body surface 2b while keeping a state of being parallel to the front-side opening 14 of the base body 10 during pivoting. The first arm portion 31a and the second arm portion 31b pivot in synchronization with each other. The first arm portion 31a and the second arm portion 31b are formed in arm shapes and extend in the horizontal direction X between the base body 10 and the lid 20. The first arm portion 31a and the second arm portion 31b extend in parallel to each other.

The first arm portion 31a and the second arm portion 31b have parts extending in the horizontal direction X at least at the closed position of the lid 20. For example, in a case where the first arm portion 31a and the second arm portion 31b are pivotable about vertical axes, the first arm portion 31a and the second arm portion 31b may have parts to be kept in the horizontal direction X while the lid 20 is performing open/close movement between the closed position and the fully opened position, or in a case where the pivot axes are tilted relative to the vertical direction, the first arm portion 31a and the second arm portion 31b may be tilted relative to the horizontal direction X at any opened position other than the closed position of the lid 20.

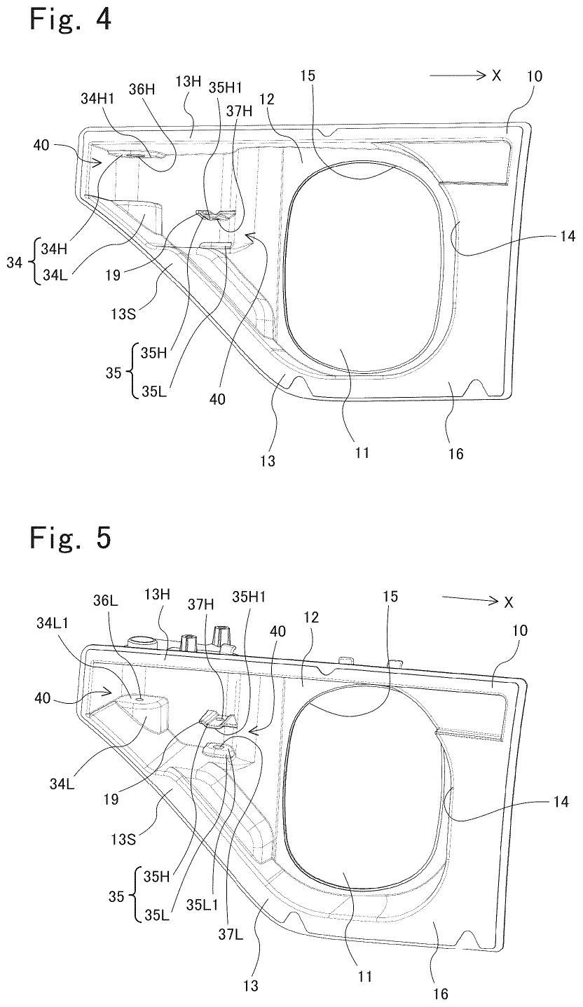

The first arm portion 31a is located on the upper side and the second arm portion 31b is located on the lower side. That is, the second arm portion 31b is located below the first arm portion 31a. The first arm portion 31a and the second arm portion 31b are located so as to be shifted from each other in the horizontal direction X. That is, the position of a pivot axis on one end side (left side in FIG. 4) in the horizontal direction X of the first arm portion 31a and the position of a pivot axis on one end side (left side in FIG. 4) in the horizontal direction X of the second arm portion 31b are shifted from each other in the horizontal direction X, and the position of a pivot axis on the other end side (right side in FIG. 4) in the horizontal direction X of the first arm portion 31a and the position of a pivot axis on the other end side (right side in FIG. 4) in the horizontal direction X of the second arm portion 31b are shifted from each other in the horizontal direction X.

An end (i.e., one end side) on the base body 10 side of the first arm portion 31a is pivotably supported by the base body 10. An end (i.e., other end side) on the lid 20 side of the first arm portion 31a is pivotably supported by the lid 20. The first arm portion 31a is pivotable about a base-body-side first axis CB1 relative to the base body 10 and is pivotable about a lid-side first axis (not shown) relative to the lid 20.

An end (i.e., one end side) on the base body 10 side of the second arm portion 31b is pivotably supported by the base body 10. An end (i.e., other end side) on the lid 20 side of the second arm portion 31b is pivotably supported by the lid 20. The second arm portion 31b is pivotable about a base-body-side second axis CB2 relative to the base body 10 and is pivotable about a lid-side second axis (not shown) relative to the lid 20. The base-body-side second axis CB2 extends in parallel to the base-body-side first axis CB1. The lid-side second axis extends in parallel to the lid-side first axis.

The base-body-side first axis CB1 is a pivot axis serving as an axis about which the first arm portion 31a pivots relative to the base body 10. The base-body-side first axis CB1 is located on the base body 10 side of the first arm portion 31a. The base-body-side first axis CB1 is formed when a base-body-side first shaft pin 32 having a rod shape penetrates a shaft hole provided in the base body 10 and a shaft hole provided in the first arm portion 31a and positions the base body 10 and the first arm portion 31a with each other. The base body 10 and the first arm portion 31a are attached to each other by the base-body-side first shaft pin 32 being inserted into the shaft hole of the base body 10 and the shaft hole of the first arm portion 31a in a state in which the shaft holes are aligned with each other.

The base-body-side second axis CB2 is a pivot axis serving as an axis about which the second arm portion 31b pivots relative to the base body 10. The base-body-side second axis CB2 is located on the base body 10 side of the second arm portion 31b. The base-body-side second axis CB2 is formed when a base-body-side second shaft pin 33 having a rod shape penetrates a shaft hole provided in the base body 10 and a shaft hole provided in the second arm portion 31b and positions the base body 10 and the second arm portion 31b with each other. The base body 10 and the second arm portion 31b are attached to each other by the base-body-side second shaft pin 33 being inserted into the shaft hole of the base body 10 and the shaft hole of the second arm portion 31b in a state in which the shaft holes are aligned with each other.

The lid-side first axis is a pivot axis serving as an axis about which the first arm portion 31a pivots relative to the lid 20. The lid-side first axis is located on the lid 20 side of the first arm portion 31a. The lid-side first axis is formed when a lid-side first shaft pin (not shown) having a rod shape penetrates a shaft hole provided in the base body 10 and a shaft hole provided in the first arm portion 31a and positions the first arm portion 31a and the lid 20 with each other. The first arm portion 31a and the lid 20 are attached to each other by the lid-side first shaft pin being inserted into the shaft hole of the first arm portion 31a and the shaft hole of the lid 20 in a state in which the shaft holes are aligned with each other.

The lid-side second axis is a pivot axis serving as an axis about which the second arm portion 31b pivots relative to the lid 20. The lid-side second axis is located on the lid 20 side of the second arm portion 31b. The lid-side second axis is formed when a lid-side second shaft pin (not shown) having a rod shape penetrates a shaft hole provided in the base body 10 and a shaft hole provided in the second arm portion 31b and positions the second arm portion 31b and the lid 20 with each other. The second arm portion 31b and the lid 20 are attached to each other by the lid-side second shaft pin being inserted into the shaft hole of the second arm portion 31b and the shaft hole of the base body 10 in a state in which the shaft holes are aligned with each other.

The first arm portion 31a and the second arm portion 31b are configured to keep a parallelogram shape having corners at four axes, i.e., the base-body-side first axis CB1, the base-body-side second axis CB2, the lid-side first axis, and the lid-side second axis, during open/close movement of the lid 20 between the closed position and the fully opened position.

The base body 10 has a base-body-side first bearing portion 34. The base-body-side first bearing portion 34 is a part supporting the first arm portion 31a pivotably about the base-body-side first axis CB1. The base-body-side first bearing portion 34 is provided as a pair of portions with the base-body-side first shaft pin 32 interposed in the axial direction therebetween. The base-body-side first bearing portion 34 has an upper-side first bearing portion 34H and a lower-side first bearing portion 34L. The upper-side first bearing portion 34H and the lower-side first bearing portion 34L are located on opposite sides separately from each other by the width of one end of the first arm portion 31a in the axial direction.

The upper-side first bearing portion 34H is formed on an inner surface of a side wall 13H (see FIG. 4) where an inner surface on the storage space 11 side of the side wall 13 faces downward. The upper-side first bearing portion 34H protrudes downward from the inner surface of the side wall 13H so that a step is formed on the inner surface. As shown in FIG. 4, the upper-side first bearing portion 34H has an upper-side first bearing surface 34H1 located on the lower side relative to the inner surface of the side wall 13H and facing downward, and a shaft hole 36H into which an upper part of the base-body-side first shaft pin 32 is inserted. The shaft hole 36H is formed so as to match the shape and the size of the upper part of the base-body-side first shaft pin 32.

The upper-side first bearing surface 34H1 is formed in such a size that allows the first arm portion 31a inserted in the shaft hole 36H to stably pivot during open/close movement of the lid 20. The upper-side first bearing surface 34H1 is formed so as to be included within a predetermined distance WH (see FIG. 7) in the radial direction from the center of the shaft hole 36H (i.e., the base-body-side first axis CB1), at least over the entire angle range where the first arm portion 31a pivots during open/close movement of the lid 20 between the closed position and the fully opened position.

The upper-side first bearing surface 34H1 is opposed in the axial direction to an area of the first arm portion 31a from the end on the base-body-side first axis CB1 side to a position at the predetermined distance WH from the base-body-side first axis CB1, during open/close movement of the lid 20. The upper surface of the first arm portion 31a is opposed in the axial direction to the upper-side first bearing surface 34H1 of the upper-side first bearing portion 34H with substantially no gap therebetween. The predetermined distance WH on the upper-side first bearing surface 34H1 is such a length that allows the first arm portion 31a to stably pivot about the base-body-side first axis CB1 relative to the base body 10, during open/close movement of the lid 20, and may be set in accordance with the outer diameter of the base-body-side first shaft pin 32 or a diameter ΦH (see FIG. 7) of the shaft hole 36H. The predetermined distance WH is set so as to satisfy WH≤3×(ΦH/2), for example.

The lower-side first bearing portion 34L is formed on an inner surface of a side wall 13S (see FIG. 4 and FIG. 5) where an inner surface on the storage space 11 side of the side wall 13 faces in an obliquely upward direction. The lower-side first bearing portion 34L protrudes upward from the inner surface of the side wall 13S so that a step is formed on the inner surface. As shown in FIG. 5, the lower-side first bearing portion 34L has a lower-side first bearing surface 34L1 located on the upper side relative to the inner surface of the side wall 13S and facing upward, and a shaft hole 36L into which a lower part of the base-body-side first shaft pin 32 is inserted. The shaft hole 36L is formed so as to match the shape and the size of the lower part of the base-body-side first shaft pin 32.

The lower-side first bearing surface 34L1 is formed in such a size that allows the first arm portion 31a inserted in the shaft hole 36L to stably pivot during open/close movement of the lid 20. The lower-side first bearing surface 34L1 is formed so as to be included within the predetermined distance WH (see FIG. 7) in the radial direction from the center of the shaft hole 36L (i.e., the base-body-side first axis CB1), at least over the entire angle range where the first arm portion 31a pivots during open/close movement of the lid 20 between the closed position and the fully opened position.

The lower-side first bearing surface 34L1 is opposed in the axial direction to an area of the first arm portion 31a from the end on the base-body-side first axis CB1 side to a position at the predetermined distance WH from the base-body-side first axis CB1, during open/close movement of the lid 20. The lower surface of the first arm portion 31a is opposed in the axial direction to the lower-side first bearing surface 34L1 of the lower-side first bearing portion 34L with substantially no gap therebetween. The predetermined distance WH on the lower-side first bearing surface 34L1 is such a length that allows the first arm portion 31a to stably pivot about the base-body-side first axis CB1 relative to the base body 10 during open/close movement of the lid 20, and may be set in accordance with the outer diameter of the base-body-side first shaft pin 32 or a diameter ΦH (see FIG. 7) of the shaft hole 36L. The predetermined distance WH is set so as to satisfy WH≤3×(ΦH/2), for example.

If the outer diameters of the upper part and the lower part of the base-body-side first shaft pin 32 are the same, the shaft hole 36H of the upper-side first bearing portion 34H and the shaft hole 36L of the lower-side first bearing portion 34L may have the same diameter. If the outer diameters of the upper part and the lower part of the base-body-side first shaft pin 32 are different from each other, the shaft hole 36H and the shaft hole 36L may have different diameters and the predetermined distances WH may also be different from each other.

The base body 10 has a base-body-side second bearing portion 35. The base-body-side second bearing portion 35 is a part supporting the second arm portion 31b pivotably about the base-body-side second axis CB2. The base-body-side second bearing portion 35 is provided as a pair of portions with the base-body-side second shaft pin 33 interposed in the axial direction therebetween. The base-body-side second bearing portion 35 has an upper-side second bearing portion 35H and a lower-side second bearing portion 35L. The upper-side second bearing portion 35H and the lower-side second bearing portion 35L are located on opposite sides separately from each other by the width of one end of the second arm portion 31b in the axial direction.

The upper-side second bearing portion 35H is formed on the vehicle outer surface of the bottom wall 12. The upper-side second bearing portion 35H protrudes toward the vehicle outer side from the vehicle outer surface of the bottom wall 12. The upper-side second bearing portion 35H is located on the lower side relative to the lower surface of the first arm portion 31a stored in the storage space 11 at the closed position of the lid 20.

The base body 10 has a bearing plate portion 19. The bearing plate portion 19 is a plate-shaped part protruding toward the vehicle outer side from the vehicle outer surface of the bottom wall 12. The bearing plate portion 19 is located between the first arm portion 31a (specifically, the lower surface thereof) and the second arm portion 31b (specifically, the upper surface thereof) at the closed position of the lid 20, and is formed as a partition between both arm portions 31a and 31b. The bearing plate portion 19 extends so as to be along the horizontal direction X, i.e., the extending direction of the first arm portion 31a and the second arm portion 31b, at the closed position of the lid 20.

The upper side of the base-body-side second bearing portion 35, i.e., the upper-side second bearing portion 35H, is formed at the bearing plate portion 19. The bearing plate portion 19 is formed in a size, a shape, and a thickness that are needed for the upper-side second bearing portion 35H to support the second arm portion 31b pivotably about the base-body-side second axis CB2.

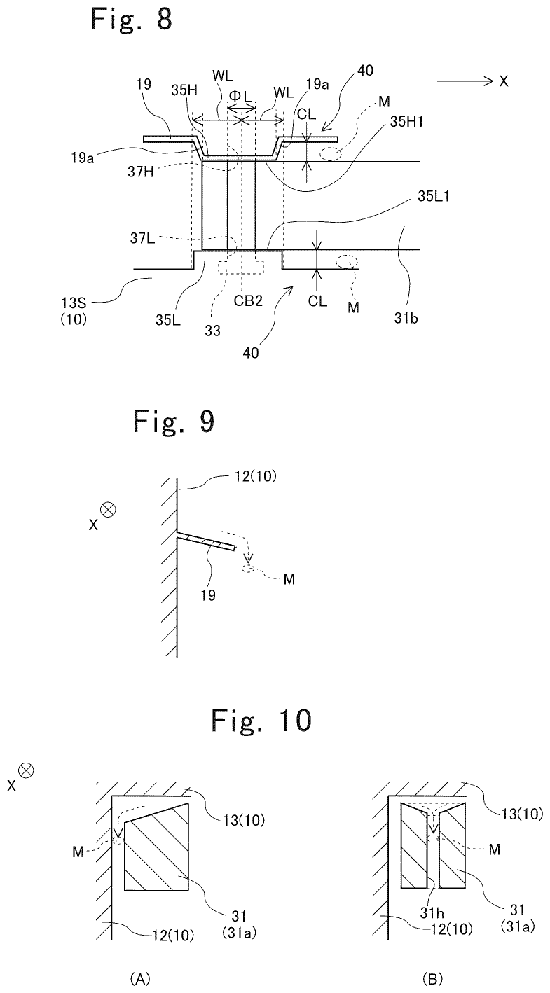

The bearing plate portion 19 is formed so as to have a step in the horizontal direction. The bearing plate portion 19 has bent portions 19a (see FIG. 8). The bent portions 19a are parts bent up and down from one end to the other end in the extending direction of the arm portions 31a and 31b at the lid-closed position in the bearing plate portion 19. The bearing plate portion 19 is formed in a groove shape and has a pair of the bent portions 19a opposed to each other in the above extending direction. The bent portions 19a serve to improve the strength and rigidity of the bearing plate portion 19 and therefore the upper-side second bearing portion 35H to pivotably support the second arm portion 31b.

Here, in the structure in which the bearing plate portion 19 is formed in a groove shape as described above, if the upper surface of the groove bottom of the bearing plate portion 19 is flat, water is readily accumulated on the upper surface, and when the water is frozen and solidified, a sliding part between the base-body-side second shaft pin 33 and the shaft hole of the upper-side second bearing portion 35H is fixed, so that pivoting of the second arm portion 31b is hampered.

Accordingly, the bearing plate portion 19 is formed such that water M put on the upper surface of the bearing plate portion 19 readily flows down from the upper surface. In this case, the water M put on the upper surface of the bearing plate portion 19 may be drained into the storage space 11 or may be drained to the outside of the storage space 11.

Specifically, as shown in FIG. 9, the upper surface (specifically, the upper surface of the groove bottom) of the bearing plate portion 19 is sloped downward from the vehicle inner side to the vehicle outer side. In order that water M put on the upper surface of the bearing plate portion 19 readily flows down from the upper surface, the bearing plate portion 19 may have, for example, a sloped shape for gathering the water M put on the upper surface to one location, and a water drain hole through which the water M gathered to the one location falls to be drained, instead of the structure in which the upper surface is sloped downward from the vehicle inner side to the vehicle outer side.

The upper-side second bearing portion 35H has an upper-side second bearing surface 35H1 facing downward, and a shaft hole 37H into which an upper part of the base-body-side second shaft pin 33 is inserted (see FIG. 4 and FIG. 5). The upper-side second bearing surface 35H1 is formed at the lower surface of the groove bottom of the bearing plate portion 19. The shaft hole 37H is formed so as to match the shape and the size of the upper part of the base-body-side second shaft pin 33.

The upper-side second bearing surface 35H1 is formed in such a size that allows the second arm portion 31b inserted in the shaft hole 37H to stably pivot during open/close movement of the lid 20. The upper-side second bearing surface 35H1 is formed so as to be included within a predetermined distance WL (see FIG. 8) in the radial direction from the center of the shaft hole 37H (i.e., the base-body-side second axis CB2), at least over the entire angle range where the second arm portion 31b pivots during open/close movement of the lid 20 between the closed position and the fully opened position.

The upper-side second bearing surface 35H1 is opposed in the axial direction to an area of the second arm portion 31b from the end on the base-body-side second axis CB2 side to a position at the predetermined distance WL from the base-body-side second axis CB2, during open/close movement of the lid 20. The upper surface of the second arm portion 31b is opposed in the axial direction to the upper-side second bearing surface 35H1 of the upper-side second bearing portion 35H with substantially no gap therebetween. The predetermined distance WL on the upper-side second bearing surface 35H1 is such a length that allows the second arm portion 31b to stably pivot about the base-body-side second axis CB2 relative to the base body 10 during open/close movement of the lid 20, and may be set in accordance with the outer diameter of the base-body-side second shaft pin 33 or a diameter ΦL (see FIG. 8) of the shaft hole 37H. The predetermined distance WL is set so as to satisfy WL≤3×(ΦL/2), for example.

The lower-side second bearing portion 35L is formed on an inner surface of a part (see FIG. 4 and FIG. 5) where an inner surface on the storage space 11 side of the side wall 13S faces upward. The lower-side second bearing portion 35L protrudes upward from the inner surface of the side wall 13S so that a step is formed on the inner surface. As shown in FIG. 5, the lower-side second bearing portion 35L has a lower-side second bearing surface 35L1 located on the upper side relative to the inner surface of the side wall 13S and facing upward, and a shaft hole 37L into which a lower part of the base-body-side second shaft pin 33 is inserted. The shaft hole 37L is formed so as to match the shape and the size of the lower part of the base-body-side second shaft pin 33.

The lower-side second bearing surface 35L1 is formed in such a size that allows the second arm portion 31b inserted in the shaft hole 37L to stably pivot during open/close movement of the lid 20. The lower-side second bearing surface 35L1 is formed so as to be included within the predetermined distance WL (see FIG. 8) in the radial direction from the center of the shaft hole 37L (i.e., the base-body-side second axis CB2), at least over the entire angle range where the second arm portion 31b pivots during open/close movement of the lid 20 between the closed position and the fully opened position.

The lower-side second bearing surface 35L1 is opposed in the axial direction to an area of the second arm portion 31b from the end on the base-body-side second axis CB2 side to a position at the predetermined distance WL from the base-body-side second axis CB2, during open/close movement of the lid 20. The lower surface of the second arm portion 31b is opposed in the axial direction to the lower-side second bearing surface 35L1 of the lower-side second bearing portion 35L with substantially no gap therebetween. The predetermined distance WL on the lower-side second bearing surface 35L1 is such a length that allows the second arm portion 31b to stably pivot about the base-body-side second axis CB2 relative to the base body 10 during open/close movement of the lid 20, and may be set in accordance with the outer diameter of the base-body-side second shaft pin 33 or a diameter ΦL (see FIG. 8) of the shaft hole 37L. The predetermined distance WL is set so as to satisfy WL≤3×(ΦL/2), for example.

If the outer diameters of the upper part and the lower part of the base-body-side second shaft pin 33 are the same, the shaft hole 37H of the upper-side second bearing portion 35H and the shaft hole 37L of the lower-side second bearing portion 35L may have the same diameter. If the outer diameters of the upper part and the lower part of the base-body-side second shaft pin 33 are different from each other, the shaft hole 37H and the shaft hole 37L may have different diameters and the predetermined distances WL may also be different from each other.

The lid 20 has a lid-side first bearing portion (not shown) supporting the first arm portion 31a pivotably about the lid-side first axis, and a lid-side second bearing portion (not shown) supporting the second arm portion 31b pivotably about the lid-side second axis. The lid-side first bearing portion and the lid-side second bearing portion may have the same structures as the base-body-side first bearing portion 34 and the base-body-side second bearing portion 35 described above.

The open/close mechanism 30 has a fixation preventing structure 40. The fixation preventing structure 40 is a structure for preventing the arm 31 from being fixed due to solidification of put water when the arm 31 pivots about the base-body-side first axis CB1 or the base-body-side second axis CB2 between the closed position and the fully opened position. That is, the fixation preventing structure 40 is a structure for preventing water M from being solidified in a state of connecting the surface of the base body 10 and the surface of the arm 31, and is a structure for preventing water M from being accumulated on a surface (in particular, an upper surface extending in the horizontal direction X) of the base body 10, the first arm portion 31a, or the second arm portion 31b to such an extent that the water M connects the surface of the base body 10 and the surface of the arm 31. A structure for preventing water M from being accumulated to such an extent that the water M connects the surfaces of both arm portions 31a and 31b may be provided also between the first arm portion 31a and the second arm portion 31b.

The fixation preventing structures 40 are formed between the base body 10 and the first arm portion 31a, and between the base body 10 and the second arm portion 31b, at the closed position of the lid 20. Specifically, the fixation preventing structure 40 is formed over a range from a position at the predetermined distance WH in the radial direction from the base-body-side first axis CB1 to the other end on the lid 20 side of the first arm portion 31a, and the fixation preventing structure 40 is formed over a range from a position at the predetermined distance WL in the radial direction from the base-body-side second axis CB2 to the other end on the lid 20 side of the second arm portion 31b.

Each fixation preventing structure 40 has a clearance CL formed in a size not smaller than a predetermined size. At the closed position of the lid 20, between the base body 10 and the first arm portion 31a, the clearance CL is continuously formed over a range from a position at the predetermined distance WH in the radial direction from the base-body-side first axis CB1 to the other end on the lid 20 side of the first arm portion 31a, and between the base body 10 and the second arm portion 31b, the clearance CL is continuously formed over a range from a position at the predetermined distance WL in the radial direction from the base-body-side second axis CB2 to the other end on the lid 20 side of the second arm portion 31b. The clearances CL are formed on each of the upper and lower sides of the first arm portion 31a, and the clearances CL are formed on each of the upper and lower sides of the second arm portion 31b.

The size of the clearance CL is set to be greater than the height of water M (see FIG. 7, FIG. 8, and FIG. 9) formed when several droplets (e.g., five droplets) of water are put and integrated by the surface tension. The size of the clearance CL is not smaller than 3 mm, for example.

In the vehicular lid open/close device 1, the base body 10 has the base-body-side first bearing portion 34 supporting the one end on the base body side of the first arm portion 31a pivotably about the base-body-side first axis CB1, and the base-body-side second bearing portion 35 supporting the one end on the base body side of the second arm portion 31b pivotably about the base-body-side second axis CB2.

The base-body-side first bearing portion 34 has the upper-side first bearing surface 34H1 and the lower-side first bearing surface 34L1 which are opposed in the axial direction to the area of the first arm portion 31a from the end on the base-body-side first axis CB1 side to the position at the predetermined distance WH in the radial direction from the base-body-side first axis CB1, when the lid 20 moves between the closed position and the fully opened position. The base-body-side second bearing portion 35 has the upper-side second bearing surface 35H1 and the lower-side second bearing surface 35L1 which are opposed in the axial direction to the area of the second arm portion 31b from the end on the base-body-side second axis CB2 side to the position at the predetermined distance WL in the radial direction from the base-body-side second axis CB2, when the lid 20 moves between the closed position and the fully opened position.

In the open/close mechanism 30, the base body 10 and the first arm portion 31a are located in a state in which the clearance CL having a size not smaller than a predetermined size is kept, except for a range to the predetermined distance WH in the radial direction from the base-body-side first axis CB1, which is an area where the base-body-side first bearing portion 34 is formed. The base body 10 and the second arm portion 31b are located in a state in which the clearance CL having a size not smaller than a predetermined size is kept, except for a range to the predetermined distance WL in the radial direction from the base-body-side second axis CB2, which is an area where the base-body-side second bearing portion 35 is formed.

That is, between the base body 10 and the arm 31, parts close to each other are not provided, except for parts needed for the bearings. Therefore, even if water M put between the base body 10 and the arm 31 is solidified, pivoting of the arm 31 relative to the base body 10 is less likely to be hampered. Thus, with the vehicular lid open/close device 1, fixation of pivoting of the arm 31 due to solidification of water put on the base body 10 or the arm 31 is prevented, whereby open/close operation of the lid 20 is prevented from being hampered.

In the vehicular lid open/close device 1, the upper-side second bearing portion 35H of the base-body-side second bearing portion 35 pivotably supporting the second arm portion 31b of the open/close mechanism 30 is formed at the plate-shaped bearing plate portion 19 protruding toward the vehicle outer side from the vehicle outer surface of the bottom wall 12 of the base body 10. The bearing plate portion 19 has the bent portions 19a for improving the strength and rigidity of the bearing. Thus, the strength and rigidity of the bearing plate portion 19 and therefore the upper-side second bearing portion 35H are improved, so that the durability of the open/close mechanism 30 is improved.

The upper surface of the bearing plate portion 19 (specifically, the upper surface of the groove bottom) is sloped downward from the vehicle inner side to the vehicle outer side so that water M put on the upper surface of the bearing plate portion 19 readily flows down from the upper surface. Thus, even in the structure in which the bearing plate portion 19 protrudes toward the vehicle outer side from the vehicle outer surface of the bottom wall 12 of the base body 10, water M put on the upper surface of the bearing plate portion 19 readily flows down from the upper surface, so that the maximum amount of water M accumulated on the upper surface of the groove bottom of the bearing plate portion 19 is reduced. Therefore, pivoting of the second arm portion 31b is prevented from being hampered due to freezing and solidification of a large amount of water M.

In the above embodiment, as the fixation preventing structure 40 for preventing fixation of pivoting of the arm due to solidification of put water, the clearance CL formed in a size not smaller than a predetermined size is provided between the base body 10 and the arm 31. However, the present disclosure is not limited thereto. As the fixation preventing structure 40, the upper surface of the arm 31 may be sloped relative to the horizontal direction X, as shown in FIG. 10(A). In this case, the upper surface of the arm 31 may be sloped relative to the horizontal direction so that water M readily flows down from an edge of the upper surface, and may be sloped from the vehicle outer side to the vehicle inner side, for example. With this configuration, water M put on the upper surface of the arm 31 is readily guided to the edge of the upper surface so as to fall, whereby fixation of pivoting of the arm 31 due to solidification of the put water is prevented.

As the fixation preventing structure 40, as shown in FIG. 10(B), the arm 31 may have a through hole 31h penetrating in the vertical direction between the upper surface and the lower surface of the arm 31, and a sloped shape sloped relative to the horizontal direction so as to gather water M put on the upper surface to through hole 31h. With this configuration, water M put on the upper surface of the arm 31 is readily guided to the through hole 31h so as to fall, whereby the through hole 31h serves as a water drain path for draining the water M entering between the base body 10 and the arm 31, and fixation of pivoting of the arm 31 due to solidification of water put on the arm 31 is prevented.

In the above two modifications, as the fixation preventing structure 40, the upper surface of the arm 31 has a sloped shape. However, as the fixation preventing structure 40, an upper surface of the base body 10 that faces upward and is opposed to the arm 31 at the lid-closed position may be sloped relative to the horizontal direction. In this case, water put on the upper surface of the base body 10 may be drained to the inside of the storage space 11 or may be drained to the outside of the storage space 11.

In the above embodiment, the upper-side first bearing portion 34H and the lower-side first bearing portion 34L of the base-body-side first bearing portion 34, and the upper-side second bearing portion 35H and the lower-side second bearing portion 35L of the base-body-side second bearing portion 35, on the base body 10, are formed so as to have steps. However, the present disclosure is not limited thereto, and the arm 31 may have steps, instead of or in addition to the steps on the base body 10 side.

Specifically, of a shaft insertion portion of the first arm portion 31a in which the base-body-side first shaft pin 32 is inserted, axial ends on both sides to which the base-body-side first bearing portion 34 is opposed may protrude outward in the axial direction from the body of the first arm portion 31a so as to form steps on the first arm portion 31a, and of a shaft insertion portion of the second arm portion 31b in which the base-body-side second shaft pin 33 is inserted, axial ends on both sides to which the base-body-side second bearing portion 35 is opposed may protrude outward in the axial direction from the body of the second arm portion 31b so as to form steps on the second arm portion 31b.

In the above embodiment, the bottom wall 12 of the base body 10 is formed in a reverse trapezoidal shape having a long upper side and a short lower side. The first arm portion 31a and the second arm portion 31b of the arm 31 of the open/close mechanism 30 are located so as to be shifted from each other in the horizontal direction X. The base-body-side second shaft pin 33 of the second arm portion 31b on the lower side is located at a position between the one end and the other end of the first arm portion 31a on the upper side, at the lid-closed position. Of the base-body-side second bearing portion 35, the upper-side second bearing portion 35H supporting the upper part of the base-body-side second shaft pin 33 is formed at the bearing plate portion 19 protruding toward the vehicle outer side from the bottom wall 12.

However, the present disclosure is not limited thereto, and the following configuration may be adopted: the bottom wall 12 of the base body 10 is formed in a trapezoidal shape having a short upper side and a long lower side; the first arm portion 31a and the second arm portion 31b of the arm 31 of the open/close mechanism 30 are located so as to be shifted from each other in the horizontal direction X; the base-body-side first shaft pin 32 of the first arm portion 31a on the upper side is located at a position between the one end and the other end of the second arm portion 31b on the lower side, at the lid-closed position; and of the base-body-side first bearing portion 34, the lower-side first bearing portion 34L supporting the lower part of the base-body-side first shaft pin 32 is formed at the bearing plate portion 19 protruding toward the vehicle outer side from the bottom wall 12.

The present disclosure is not limited to the embodiments and the modifications described above, and various changes may be made without departing from the gist of the present disclosure. The description discloses not only technical features shown by the reference relationship described in the claims at the time of filing of the present application but also technical features obtained by combining matters described in the claims as appropriate.

This application claims priority on Japanese Patent Application No. 2024-052578 filed in Japan on Mar. 27, 2024, the entire contents of which are incorporated herein by reference.

1. A vehicular lid open/close device comprising:
a box-shaped base body attached to a vehicle body and having a storage space storing a replenishment port for energy replenishment for a vehicle, and a front-side opening through which the replenishment port in the storage space is exposed to a vehicle outer side;
a lid movable between a closed position where the front-side opening is closed and the replenishment port is covered, and an opened position where the front-side opening is opened and the replenishment port is exposed to the vehicle outer side; and
an open/close mechanism configured to perform open/close movement of the lid relative to the base body between the closed position and the opened position, wherein
the open/close mechanism has an arm extending so as to connect the base body and the lid and supporting the lid openably/closably relative to the base body, the arm being configured to be stored in the storage space at the closed position of the lid,
the arm includes
a first arm portion supported by the base body pivotably about a base-body-side first axis on the base body side, and supported by the lid pivotably about a lid-side first axis on the lid side, and
a second arm portion located below the first arm portion, the second arm portion being supported by the base body pivotably about a base-body-side second axis extending in parallel to the base-body-side first axis on the base body side, and the second arm portion being supported by the lid pivotably about a lid-side second axis extending in parallel to the lid-side first axis on the lid side,
the first arm portion and the second arm portion have parts extending in a horizontal direction at least at the closed position of the lid,
the base body has
a base-body-side first bearing portion provided so as to face the storage space and supporting the first arm portion pivotably about the base-body-side first axis, and
a base-body-side second bearing portion provided so as to face the storage space and supporting the second arm portion pivotably about the base-body-side second axis, and
the open/close mechanism has a fixation preventing structure configured to prevent fixation of pivoting of the arm due to solidification of put water, the fixation preventing structure being formed between the base body and the first arm portion over a range from a first position at a first predetermined distance in a radial direction from the base-body-side first axis to an end on the lid side of the first arm portion, or being formed between the base body and the second arm portion over a range from a second position at a second predetermined distance in the radial direction from the base-body-side second axis to an end on the lid side of the second arm portion, at the closed position of the lid.

2. The vehicular lid open/close device according to claim 1, wherein
the fixation preventing structure has a clearance formed in a size not smaller than a predetermined size, the clearance being formed between the base body and the first arm portion continuously over a range from the first position to the end on the lid side of the first arm portion, or being formed between the base body and the second arm portion continuously over a range from the second position to the end on the lid side of the second arm portion, at the closed position of the lid.

3. The vehicular lid open/close device according to claim 1, wherein
the fixation preventing structure has a water drain path through which water entering between the base body and the first arm portion or between the base body and the second arm portion is drained, at the closed position of the lid.

4. The vehicular lid open/close device according to claim 1, wherein
the base body has
a bottom wall having a back-side opening through which the replenishment port is exposed to the storage space from a vehicle inner side, and
a bearing plate portion at which an upper side of the base-body-side second bearing portion is formed, the bearing plate portion protruding toward a vehicle outer side from a vehicle outer surface of the bottom wall, the bearing plate portion being located between the first arm portion and the second arm portion at the closed position of the lid, and
an upper surface of the bearing plate portion is sloped downward from the vehicle inner side to the vehicle outer side, as the fixation preventing structure.

5. The vehicular lid open/close device according to claim 1, wherein
the base body has
a bottom wall having a back-side opening through which the replenishment port is exposed to the storage space from a vehicle inner side, and
a bearing plate portion at which a lower side of the base-body-side first bearing portion or an upper side of the base-body-side second bearing portion is formed, the bearing plate portion protruding toward a vehicle outer side from a vehicle outer surface of the bottom wall, the bearing plate portion being located between the first arm portion and the second arm portion at the closed position of the lid, and
the bearing plate portion extends so as to be along an extending direction of the first arm portion or the second arm portion at the closed position of the lid, and has a bent portion bent up and down.

6. The vehicular lid open/close device according to claim 1, wherein
the base-body-side first bearing portion has a first bearing surface which is opposed in an axial direction to an area of the first arm portion from an end on the base-body-side first axis side to the first position when the lid moves between the closed position and the opened position, and
the base-body-side second bearing portion has a second bearing surface which is opposed in the axial direction to an area of the second arm portion from an end on the base-body-side second axis side to the second position when the lid moves between the closed position and the opened position.
